(19) United States
(12) Patent Application Publication
(10) Pub. No.: US 2023/0044991 A1
(43) Pub. Date: Feb. 9, 2023

(54) PAGE MAP RENUMBERING TO REDUCE ERROR CORRECTION FAILURES AND IMPROVE PROGRAM TIME UNIFORMITY

(71) Applicant: Intel Corporation, Santa Clara, CA (US)

(72) Inventors: Shantanu Rajwade, Santa Clara, CA (US); Kartik Ganapathi, Santa Clara, CA (US); Rohit Shenoy, Fremont, CA (US); Kristopher Gaewsky, El Dorado Hills, CA (US); MarkAnthony Golez, Folsom, CA (US); Vivek Angoth, Longmont, CO (US); Pranav Kalavade, San Jose, CA (US); Sarvesh Gangadhar, Santa Clara, CA (US)

(21) Appl. No.: 17/393,877

(22) Filed: Aug. 4, 2021

(51) Int. Cl. G06F 3/06

(52) U.S. Cl. CPC G06F 3/0659; G06F 3/0619; G06F 3/0644; G06F 3/0679

(57) ABSTRACT

Systems, apparatuses and methods may provide for technology that detects a request to program a NAND memory containing a plurality of dies and programs the NAND memory on a stripe-by-stripe basis, wherein each stripe spans the plurality of dies and includes multiple types of pages. The multiple types of pages may reduce program time variability across the stripes and reduce the error susceptibility of the NAND memory.

### TECHNICAL FIELD

Embodiments generally relate to memory structures. More particularly, embodiments relate to page map renumbering to reduce error correction failures and improve program time uniformity in NAND memory.

### BACKGROUND

A solid state drive (SSD) may include NAND memory cells distributed across multiple dies. SSDs including NAND memory may be arranged such that the smallest unit that may be erased is referred to as a block. Each block may include several memory pages (e.g., 64, 128 or more). These blocks may be grouped into several planes (e.g., 4 or more) within a NAND memory die. Each plane may be an independent unit and may be capable of executing various NAND operations, independent of other planes within the NAND memory die. Additionally, each plane may be partitioned into multiple inhibit tile group (ITGs) having a granularity smaller than a plane (e.g., 4 ITGs = 1 plane). Generally, data included in NAND memory planes that span across multiple NAND memory dies may be exclusive ORed (XORed) together to compute XOR parity information for error correction code (ECC) purposes.

An SSD stripe may include data stored in given memory pages for these NAND memory planes spanning across the multiple NAND memory dies that are XORed together to compute XOR parity information. An SSD stripe typically consists of the same page number (e.g., type and location on a wordline/WL or sub-block/SB) from every die. SSD stripes that are dedicated to pages with an intrinsically high raw bit error rate (RBER, e.g., edge WLs, top page-type) are more likely to encounter an XOR fatal event. Additionally, write uniformity (e.g., the ratio of minimum write bandwidth to average write bandwidth) of the SSD may be negatively impacted during the programming of stripes that are dedicated to WLs/locations with a slow program time.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of a comparative example of a conventional stripe and a stripe according to an embodiment;

FIG. 2 is a flowchart of an example of a method of operating a performance-enhanced SSD according to an embodiment;

FIG. 3A is an illustration of a comparative example of a conventional striping scheme and a logical page address reordering scheme according to an embodiment;

FIG. 3B is a flowchart of an example of a method of programming NAND memory in accordance with the logical page address reordering scheme of FIG. 3A;

FIG. 4A is an illustration of an example of a wordline start reordering scheme according to an embodiment;

FIG. 4B is a flowchart of an example of a method of programming NAND memory in accordance with the wordline start reordering scheme of FIG. 4A;

FIG. 5A is an illustration of an example of a die prefilling scheme to an embodiment;

FIG. 5B is a flowchart of an example of a method of programming NAND memory in accordance with the die prefilling scheme of FIG. 5A;

FIG. 6 is a chart of an example of a reduced read disturbance susceptibility according in NAND memory to an embodiment;

FIG. 7 is a chart of an example of a reduced program time variability across stripes according to an embodiment; and

FIG. 8 is a block diagram of an example of a performance-enhanced computing system according to an embodiment.

### DESCRIPTION OF EMBODIMENTS

RBER and the distribution of RBER is not uniform across all logical page numbers on a NAND die. Process marginalities and the choice of manufacturing parameter adjustments (e.g., trimming) can make certain physical locations and certain page types susceptible for specific fail modes. Examples are cells located close to the edge of a pillar (e.g., in three-dimensional/3D NAND memory) being susceptible to higher window loss from cross temperature read-out or the page type containing the highest read (read level seven/R7 in tri-level cell/TLC memory) being more susceptible to single bit charge loss (SBCL) from a long retention time. Furthermore, RBER tends to degrade with cycling, change of operating temperature of the NAND. This degradation is not uniform on all pages in the block, as certain locations are more susceptible to higher process, cell current and wordline resistance variations. Other physical defects on the NAND strings and WLs arising from patterning the 3D NAND array are generally concentrated at specific page locations. An ECC uncorrectable event resulting from high RBER from any of these defects may be recovered by invoking XOR parity on the SSD. A conventional SSD stripe of user data, however, includes the same logical page from every die on the SSD. Typically, one die or one ITG/plane in one die holds the XOR parity for the stripe. This arrangement makes the stripe containing these “weak” pages also marginally worse for XOR fatality, compared to other stripes in the SSD.

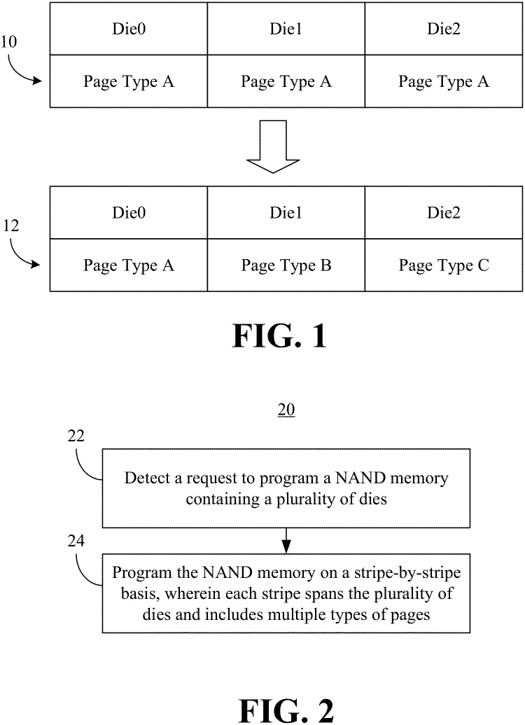

Turning now to FIG. 1, a conventional SSD stripe 10 is shown in which the stripe 10 spans a plurality of dies (“Die0”, “Die1”, “Die2”) and is dedicated to a single type of page (“Page Type A”). In this regard, read bit-error-rate and program time depend largely (e.g., greater than 1.5X variation from mean), depending on the physical location and type of the page within the block. For example, pages located at an edge WL typically have high a RBER and slower program time (T_{prog}). The SSD may use ITG, plane and/or die-level XOR parity to protect against ECC uncorrectable data emerging from one or more planes or dies. In such a case, if the “Page Type A” page has an intrinsically high RBER (e.g., edge WLs, top page-type), the conventional SSD stripe 10 is more likely to encounter an XOR fatal event. Additionally, if the “Page Type A” page has a relatively slow program time, the write uniformity of the SSD may be negatively impacted during programming.

By contrast, an enhanced SSD stripe 12 spans a plurality of dies while including multiple types of pages (“Page Type A”, “Page Type B”, “Page Type C”). As will be discussed in greater detail, the multiple types of pages in the enhanced SSD stripe 12 may include two or more of an extra page, an upper page or a lower page. Additionally, the enhanced SSD stripe 12 may include pages from multiple wordline positions. Embodiments improve XOR robustness and improve write uniformity by: 1) scrambling physical to logical page location mapping in every die and/or 2) changing band stripe mapping in the SSD by prefilling dummy data up to a pre-determined unique page number for every die. Introducing diversification (e.g., two or more unique page numbers/locations) in the enhanced SSD stripe 12 improves XOR robustness by a factor of ~2X and input/output operations per second (IOPs) uniformity by more than 20% in quad level cell (QLC) SSDs.

FIG. 2 shows a method 20 of operating a performance-enhanced SSD. The method 20 may generally be implemented in a device controller and/or memory chip controller. More particularly, the method 20 may be implemented in one or more modules as a set of logic instructions stored in a machine- or computer-readable storage medium such as random access memory (RAM), read only memory (ROM), programmable ROM (PROM), firmware, flash memory, etc., in configurable hardware such as, for example, programmable logic arrays (PLAs), FPGAs, complex programmable logic devices (CPLDs), in fixed-functionality hardware using circuit technology such as, for example, application specific integrated circuit (ASIC), complementary metal oxide semiconductor (CMOS) or transistor-transistor logic (TTL) technology, or any combination thereof.

Illustrated processing block 22 provides for detecting a request to program a NAND memory containing a plurality of dies. The request may originate from, for example, an application executing on a host processor (e.g., central processing unit/CPU). Block 24 programs the NAND memory on a stripe-by-stripe basis, wherein each stripe spans the plurality of dies and includes multiple types of pages. The method 20 enhances performance at least to the extent that the multiple types of pages reduce program time variability across the stripes and/or error susceptibility (e.g., single bit charge loss or read disturbance due to charge gain) of the NAND memory. The method 20 also improves XOR robustness at a given parity allocation (e.g., no change to the NAND bill of materials/BoM).

More particularly, the method 20 introduces diversity in the stripe so that not all pages contributing to the stripe are equally weak for RBER and/or slow to program. Diversification can be achieved in at least three ways: 1) reordering page types at a given physical location on the die (e.g., a logical page address reordering scheme), 2) modifying the logical to physical pagemap on the die (e.g., a wordline start reordering scheme), and 3) introducing dummy prefill unique to every die on the SSD at the beginning of life (e.g., a die prefilling scheme at first power on).

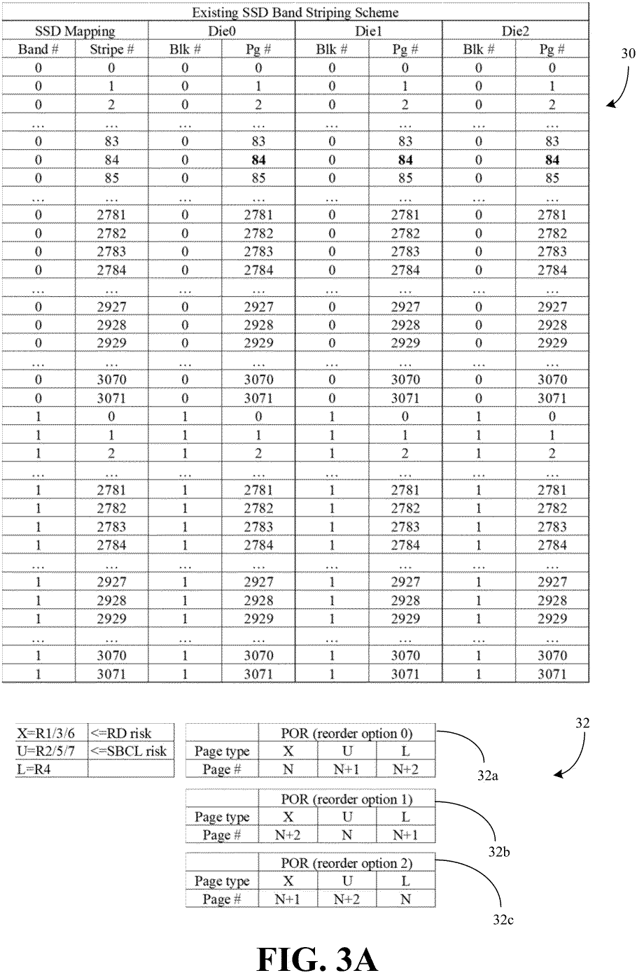

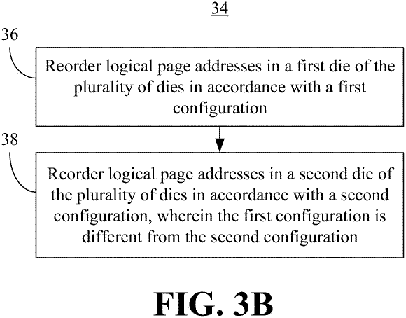

FIG. 3A shows a conventional striping scheme 30 in which an SSD spans stripes across three dies. Each NAND die has blocks with 3072 pages (e.g., 128 WLs * 8 SBs * 3 bits/cell). Each stripe is dedicated to the same unique page allocated from every die. For example, stripe #2 in band #0 includes page #2 from block (“blk”) #0 of every die. In this example, page #84 on every block is marginal (e.g., weak) for ECC uncorrectable error. Accordingly, stripe #84 in every SSD band is more likely to encounter an XOR fatal error (e.g., relatively high probability of multiple pages failing due to an ECC uncorrectable RBER and cannot be recovered by an XOR-rebuild). Thus, page #84 is assumed to be weaker (e.g., more susceptible to ECC uncorrectable event) than a median RBER page on any block. Typically, a block could have anywhere between 1 - 5 % of pages that are inherently weaker than the normal distribution of RBER in the block. As seen from this example, stripe #84 in every SSD band is more susceptible for XOR fatality because all pages making up the stripe are weak (e.g., page #84 on every die). Similarly, certain locations (e.g., typically the same) on the block are slower to program. This systematic deviation in programming time also impacts write uniformity on those SSD stripes.

As already noted, embodiments include at least three solutions to diversify the SSD stripe so that not every page contributing to the stripe is weak (e.g., higher RBER than the normal distribution). In one example, a logical page address reordering scheme 32 (32a-32c) reorders the pages in a given physical location. The scheme 32 does not change the logical to physical mapping of the pages and the WLs. The scheme 32 does reorder, however, the sequence in which the pages at a given physical location are programmed in a given programming pass.

In SSDs, multi-level NAND-type flash memory (“NAND memory”) may be organized into multiple cells, with each cell containing multiple bits of data. In such a case, the number of bits per cell may depend on how many distinct voltage levels can be achieved during program operation(s). For example, to support two bits per cell, four voltage levels may be called for in order to distinguish between the four possible combinations of ones and zeros (11, 01, 00, 10) in a cell. More generally, in multi-level cell (MLC) memory devices such as MLC NAND flash memory, cells are typically programmed into one of 2^{N} possible levels to store N bits of information. To read this data, a series of read operations at predetermined read levels (e.g., a subset of 2^{N}-1 read levels) are performed.

Thus, a TLC architecture includes a set of multi-level NVM cells (cell₀, cell₁, ..., cellₙ), wherein each cell includes three bits (Bit 1, Bit 2, Bit 3). The cells may be programmed (e.g., written to) and read according to the page, with each page corresponding to a particular bit. More particularly, a lower page (LP or “L”) may correspond to Bit 3, an upper page (UP or “U”, e.g., intermediate page) may correspond to Bit 2 and an extra page (XP or “X”) may correspond to Bit 1. Thus, the multiple types of pages contained in a strip may include two or more of an XP, a UP or an LP in a TLC architecture. Additionally, each bit may be individually programmed to a certain voltage level, wherein the total number of voltage levels (e.g., eight in this case) enable all possible bit combinations to be distinguished from one another.

In a 1-pass TLC programming example, the NAND die can be configured in one of the three reordering configurations. If the three pages being programmed have logical page addresses of N, N+1, N+2, in a first configuration 32a (e.g., “option 0”), logical page #N will be XP, logical page #N+1 will be UP and page #N+2 would be LP, which defines an X-U-L sequence. A die configured in a second configuration 32b (e.g., “option 1”) and a third configuration 32c (e.g., “option 2”) will instead have a U-L-X and L-X-U sequence, respectively. In an embodiment, the SSD configures every die randomly in one of the three options at the beginning of life (e.g., first power on).

Thus, using the example of an SSD with three NAND dies, the configurations may be conducted in the following manner: die0 in option 0, die1 in option 1 and die2 in option 2. Given this configuration, stripe #84 may contain logical page #84 from every die. However, only one die (e.g., die0 page #84) corresponds to the actual physical location and page-type that renders the page weak. In other words, page #84 on die1 and die2 are not weak (e.g., page #86 and page #85 respectively are weak), which improves XOR robustness for stripe #84. Note that weakness related to page-types (read disturbance/RD, SBCL) are improved with this approach. As will be discussed in greater detail, other schemes may be used to address write uniformity and weaknesses resulting from process marginalities such as higher cross temperature window loss or higher defect probability.

FIG. 3B shows a method 34 of programming NAND memory in accordance with a logical page address reordering scheme such as, for example, the scheme 32 (FIG. 3A). The method 34 may generally be incorporated into block 24 (FIG. 2), already discussed. More particularly, the method 34 may be implemented in one or more modules as a set of logic instructions stored in a machine- or computer-readable storage medium such as RAM, ROM, PROM, firmware, flash memory, etc., in configurable hardware such as, for example, PLAs, FPGAs, CPLDs, in fixed-functionality hardware using circuit technology such as, for example, ASIC, CMOS or TTL technology, or any combination thereof.

Illustrated processing block 36 reorders logical page addresses in a first die (e.g., die1) of the plurality of dies in accordance with a first configuration. Additionally, block 38 reorders logical page addresses in a second die (e.g., die2) in accordance with a second configuration, wherein the first configuration is different from the second configuration. In an embodiment, the method 34 bypasses a reordering of a third die (e.g., die0). Thus, the method 34 further reduces read disturbance susceptibility of the NAND memory by changing logical page address ordering across the plurality of dies.

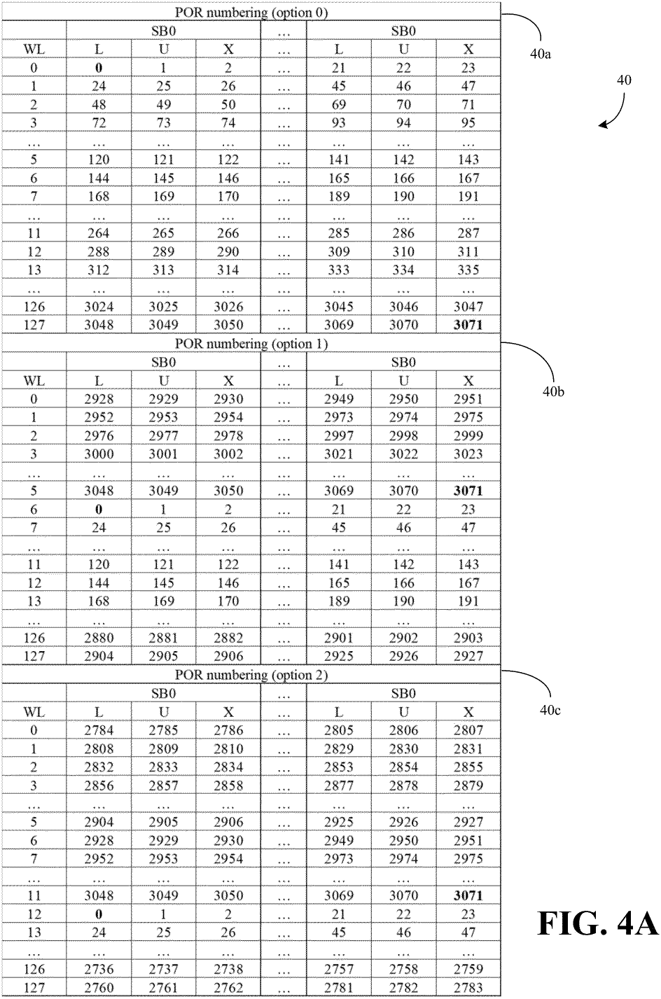

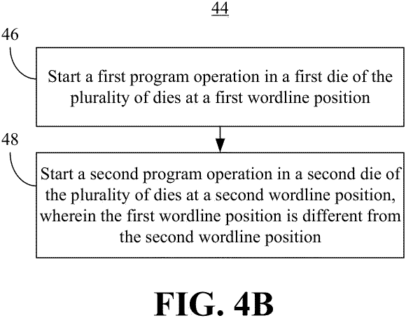

FIG. 4A shows a wordline start reordering scheme 40 (40a-40C) that changes the physical to logical mapping of the pages within a block. As an example, a first wordline position 40a (e.g., page renumbering “option 0” or default) has pg0 beginning from active WL0 and the last page (pg3071) end on the last active WL 127. A second wordline position 40b (e.g., renumbering “option 1”) shows that the block is programmed starting from pg0, which is relocated to WL6. The last active WL127 accommodates pages up to pg2927. Pages from pg2928 to pg3071 are subsequently placed from active WL0 to active WL5. A third wordline position (e.g., renumbering “option 2”) shows another example of the first page placed on active WL12 and pages subsequently wrapping around from WL127 to WL0. The last page pg3071 is placed on WL11.

The scheme 40 therefore changes the mapping of logical pages to physical location within the block. In this example, the block is programmed from active WL0 (logical pg0) to active WL127 (logical pg3071) serially. In option 1 (e.g., for illustration purposes), the block is programmed starting with WL6 (logical pg0) to WL127 (logical pg2927). The sequence then programs the remaining WL0 (pg2928) to WL5 (pg3071) subsequently. Option 2 shows the pg0 located on WL12. In an embodiment, the SSD configures the NAND to be in one of the above renumbering options at the first power on. The illustrated scheme 40 is more comprehensive than the scheme 32 (FIG. 3A), since the scheme 40 avoids clustering of physical defects as well as page-type specific defects on any stripe. The scheme 40 also addresses write-uniformity degradation by combining slower WLs in one or more die with median WLs from remaining die in the SSD band. Other schemes may be used to avoid engineering, trimming and qualifying the NAND memory under all renumbering options.

FIG. 4B shows a method 44 of programming NAND memory in accordance with a wordline start reordering scheme such as, for example, the scheme 40 (FIG. 4A). The method 44 may generally be incorporated into block 24 (FIG. 2), already discussed. More particularly, the method 44 may be implemented in one or more modules as a set of logic instructions stored in a machine- or computer-readable storage medium such as RAM, ROM, PROM, firmware, flash memory, etc., in configurable hardware such as, for example, PLAs, FPGAs, CPLDs, in fixed-functionality hardware using circuit technology such as, for example, ASIC, CMOS or TTL technology, or any combination thereof.

Illustrated processing block 46 starts a first program operation in a first die of the plurality of dies at a first wordline position. Block 48 starts a second program operation in a second die of the plurality of dies at a second wordline position, wherein the first wordline position is different from the second wordline position. The method 44 therefore further enhances performance by reducing program time variability across the stripes and reducing read disturbance susceptibility of the NAND memory.

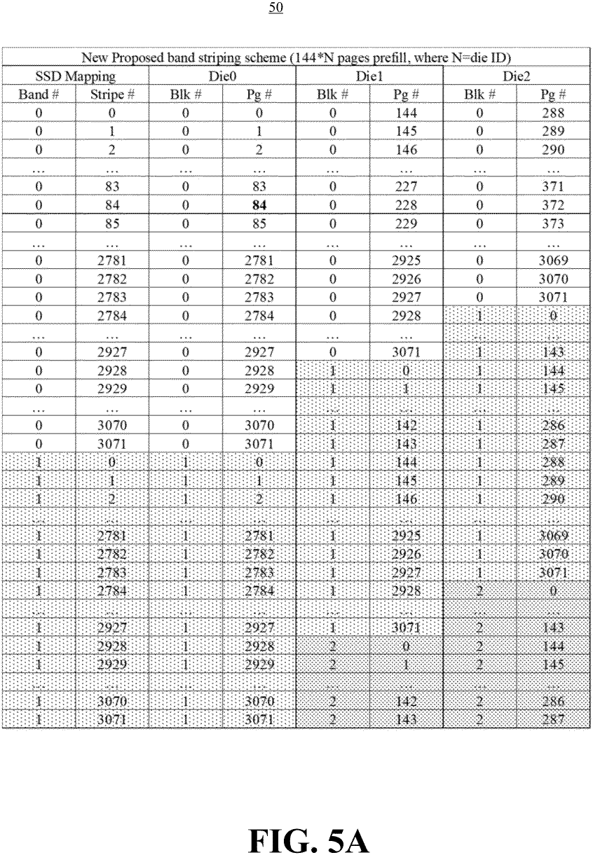

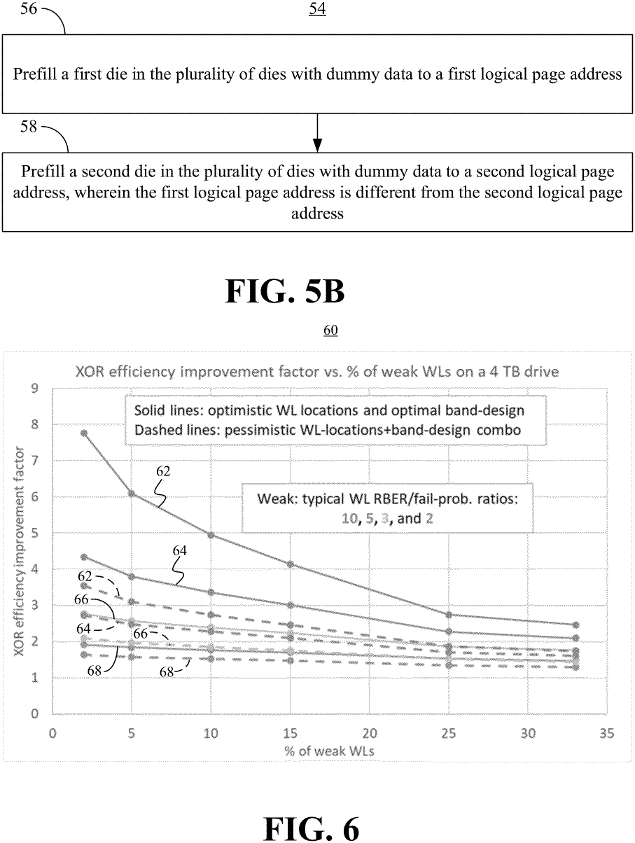

FIG. 5A shows a die prefilling scheme 50 that changes default stripe mapping in a band. Each die in the SSD (e.g., at first power on) is prefilled with dummy data up to a unique page. The illustrated example shows an SSD with three NAND dies - die0 is not prefilled, die1 is prefilled with dummy data up to pg #143 and die2 is prefilled with dummy data up to pg #287. Actual user data of stripe #0 is written into pg #0 in die0, pg #144 in die1 and pg #288 in die2. Stripe #3071 now includes the last page #3071 from die0, pg #143 in die1 (e.g., starting the next block, blk #1) and pg #287 from die2 (starting the next block, blk #1). Stripe #0 for the next band begins with pg #0 from the blk #1 in die0 and pg #144 and pg #288 from blk #1 in die1 and die2, respectively. The new stripe mapping therefore has only one weak page in stripe #84 (e.g., pg #84 from die0) instead of three weak pages as shown in the conventional striping scheme 30 (FIG. 3A). Accordingly, the likelihood of encountering an XOR fatality in field is reduced.

The scheme 50 therefore effectively achieves the same results of the scheme 40 by reconfiguring the stripe mapping on the SSD. At the beginning of life for an SSD on the first band (e.g., performed only once), every block (e.g., die) is prefilled with dummy data up to a unique logical page. The new mapping achieves a de-clustering of weak physical locations and page-types to improve XOR robustness. Write uniformity also improves due to the combination of slow and average program time within a stripe.

The scheme 50 does not require any changes to NAND array engineering or qualification. Moreover, the dummy prefill process is not expected to impact performance since the process is only done on the first band at the beginning of life (e.g., first power up).

FIG. 5B shows a method 54 of manufacturing SSD dies accordance with a die prefilling scheme such as, for example, the scheme 50 (FIG. 5A). The method 54 may generally be incorporated into block 24 (FIG. 2), already discussed. More particularly, the method 54 may be implemented in one or more modules as a set of logic instructions stored in a machine- or computer-readable storage medium such as RAM, ROM, PROM, firmware, flash memory, etc., in configurable hardware such as, for example, PLAs, FPGAs, CPLDs, in fixed-functionality hardware using circuit technology such as, for example, ASIC, CMOS or TTL technology, or any combination thereof.

Illustrated processing block 56 prefills a first die in the plurality of dies with dummy data to a first logical page address. Block 58 prefills a second die in the plurality of dies with dummy data to a second logical page address, wherein the first logical page address is different from the second logical page address. The method 54 further enhances performance at least to the extent that filling the dies with dummy data to different logical page addresses reduces program time variability across the stripes and/or read disturbance susceptibility of the NAND memory.

FIG. 6 shows a plot 60 demonstrating the improvement in XOR fail probability as a function of percentage weak WLs, in accordance with the die prefilling scheme 50 (FIG. 5A) or the wordline start reordering scheme 40 (FIG. 4A), already discussed. In a typical case of a NAND die, the percentage of weak WLs can range from 5 - 15 %. The ratio of fail probability of a weak WL to an average WL is ~ 2 - 3X. In the illustrated example, curves 62 correspond to a ratio of 10, curves 64 correspond to a ratio of 5, curves 66 correspond to a ratio of 3, and curves 68 correspond to a ratio of 2. In such a case, the improvement in XOR fail rate can be a factor of 1.5X (e.g., pessimistic combination of WLs) to greater than 2X (e.g., optimized combination of WLs).

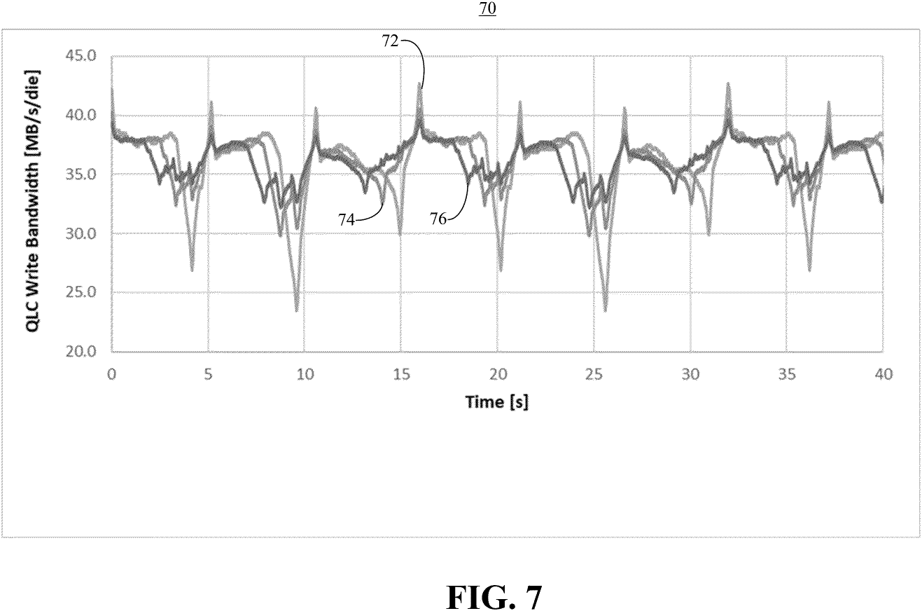

FIG. 7 shows a plot 70 demonstrating the improvement in write throughput uniformity for a quad-level cell (QLC) based SSD with the die prefilling scheme 50 (FIG. 5A) or the wordline start reordering scheme 40 (FIG. 4A), already discussed. The illustrated plot 70 includes a conventional curve 72 (e.g., all dies with the same page number: write uniformity = 65%), a single stagger curve 74 (e.g., SSD band formed with two distinct page numbers: write uniformity = 82%), and a double stagger curve 76 (e.g., SSD band formed with three distinct page numbers: write uniformity = 89%). Thus, under the default (e.g., plan of record/POR) striping condition (e.g., same page from every die), sequential write throughput can reduce up to 65% of the average throughput. With appropriate diversification of pages within a stripe (e.g., physical location on the block), throughput nonuniformity can be significantly improved. In this particular example, when the diversity in the number of unique page numbers in the stripe is two (e.g., 50% of dies have page #X and the other 50% dies have page #Y, in stripe #X), with sufficient spacing between page #X and page #Y, uniformity improves from 65% to 82%. Increasing the diversity to three yields further improvement to 89%.

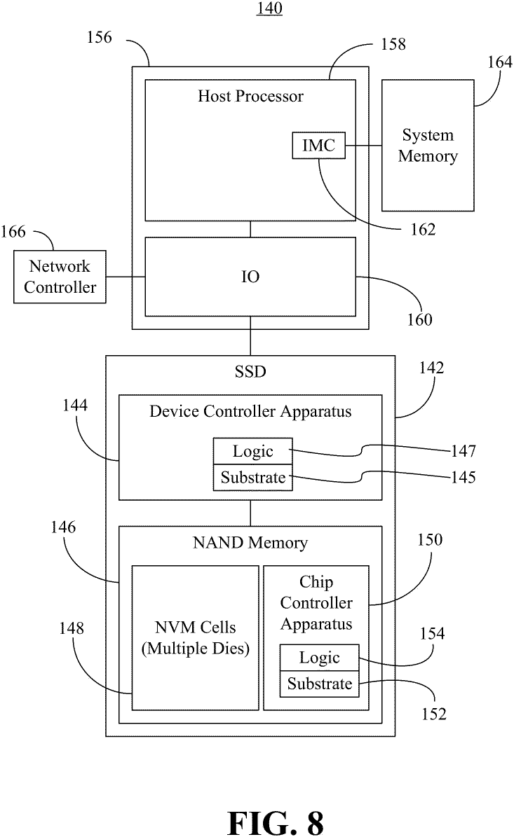

Turning now to FIG. 8, a computing system 140 is shown. In the illustrated example, a performance-enhanced SSD 142 includes a device controller apparatus 144, and a NAND memory 146 having a set of NVM cells 148 and a chip controller apparatus 150 that includes a substrate 152 (e.g., silicon, sapphire, gallium arsenide) and logic 154 (e.g., transistor array and other integrated circuit/IC components) coupled to the substrate 152. Similarly, the device controller apparatus 144 may also include a substrate 145 and logic 147 coupled to the substrate 145. In some embodiments, the NVM cells 148 include a transistor-less stackable cross point architecture (e.g., 3D Xpoint, referred to as INTEL OPTANE) in which the NVM cells 148 (e.g., sitting at the intersection of word lines and bit lines) are distributed across a plurality of storage dies and are individually addressable. In such a case, bit storage may be based on a change in bulk resistance. In an embodiment, the device controller apparatus 144 and the chip controller apparatus 150 are two parts of the same ASIC. The logic 154 and/or the logic 147, which may include one or more of configurable or fixed-functionality hardware, may be configured to perform one or more aspects of the method 20 (FIG. 2), the method 34 (FIG. 3B), the method 44 (FIG. 4B) and/or the method 54 (FIG. 5B), already discussed.

Thus, the logic 154 and/or the logic 147 detects a request to program the NAND memory 146 and programs (e.g., in response to the request) the NAND memory 146 on a stripe-by-stripe basis, wherein each stripe spans the plurality of dies and includes multiple types of pages. In an embodiment, the multiple types of pages include two or more of an extra page (XP), an upper page (UP) or a lower page (LP). The SSD 142 is considered performance-enhanced at least to the extent that incorporating multiple types of pages into each stripe reduces program time variability and/or reduces the error susceptibility of the NAND memory 146.

The illustrated system 140 also includes a system on chip (SoC) 156 having a host processor 158 (e.g., central processing unit/CPU) and an input/output (IO) module 160. The host processor 158 may include an integrated memory controller 162 (IMC) that communicates with system memory 164 (e.g., RAM dual inline memory modules/DIMMs). The illustrated IO module 160 is coupled to the SSD 142 as well as other system components such as a network controller 166.

In one example, the logic 154 and the logic 147 include transistor channel regions that are positioned (e.g., embedded) within the substrates 152, 145, respectively. Thus, the interface between the logic 154 and the substrate 152 - and between the logic 147 and the substrate 145 - may not be an abrupt junction. The logic 154, 147 may also be considered to include an epitaxial layer that is grown on an initial wafer of the substrates 152, 145, respectively.

### Additional Notes and Examples

Example 1 includes a performance-enhanced solid state drive (SSD) comprising a device controller, a chip controller, and a NAND memory containing a plurality of dies, wherein one or more of the device controller or the chip controller include logic coupled to one or more substrates, the logic to detect a request to program the NAND memory and program the NAND memory on a stripe-by-stripe basis, wherein each stripe spans the plurality of dies and includes multiple types of pages.

Example 2 includes the SSD of Example 1, wherein the multiple types of pages are to reduce a program time variability across the stripes.

Example 3 includes the SSD of Example 1, wherein the multiple types of pages are to reduce an error susceptibility of the NAND memory.

Example 4 includes the SSD of Example 1, wherein to program the NAND memory on the stripe-by-stripe basis, the logic is to reorder logical page addresses in a first die of the plurality of dies in accordance with a first configuration, and reorder logical page addresses in a second die of the plurality of dies in accordance with a second configuration, wherein the first configuration is different from the second configuration.

Example 5 includes the SSD of Example 1, wherein to program the NAND memory on the stripe-by-stripe basis, the logic is to start a first program operation in a first die of the plurality of dies at a first wordline position, and start a second program operation in a second die of the plurality of dies at a second wordline position, wherein the first wordline position is different from the second wordline position, and wherein each stripe includes pages from multiple wordline locations.

Example 6 includes the SSD of Example 1, wherein the logic is to prefill a first die in the plurality of dies is prefilled with dummy data to a first logical page address, and prefill a second die in the plurality of dies is prefilled with dummy data to a second logical page address, wherein the first logical page address is different from the second logical page address, and wherein each stripe includes pages from multiple wordline locations.

Example 7 includes the SSD of any one of Examples 1 to 6, wherein the multiple types of pages include two or more of an extra page, an upper page or a lower page.

Example 8 includes a semiconductor apparatus comprising one or more substrates, and logic coupled to the one or more substrates, wherein the logic is implemented at least partly in one or more of configurable or fixed-functionality hardware, the logic to detect a request to program a NAND memory containing a plurality of dies, and program the NAND memory on a stripe-by-stripe basis, wherein each stripe spans the plurality of dies and includes multiple types of pages.

Example 9 includes the semiconductor apparatus of Example 8, wherein the multiple types of pages are to reduce a program time variability across the stripes.

Example 10 includes the semiconductor apparatus of Example 8, wherein the multiple types of pages are to reduce an error susceptibility of the NAND memory.

Example 11 includes the semiconductor apparatus of Example 8, wherein to program the NAND memory on the stripe-by-stripe basis, the logic is to reorder logical page addresses in a first die of the plurality of dies in accordance with a first configuration, and reorder logical page addresses in a second die of the plurality of dies in accordance with a second configuration, wherein the first configuration is different from the second configuration.

Example 12 includes the semiconductor apparatus of Example 8, wherein to program the NAND memory on the stripe-by-stripe basis, the logic is to start a first program operation in a first die of the plurality of dies at a first wordline position, and start a second program operation in a second die of the plurality of dies at a second wordline position, wherein the first wordline position is different from the second wordline position, and wherein each stripe includes pages from multiple wordline locations.

Example 13 includes the semiconductor apparatus of Example 8, wherein the logic is to prefill a first die in the plurality of dies with dummy data to a first logical page address, and prefill a second die in the plurality of dies with dummy data to a second logical page address, wherein the first logical page address is different from the second logical page address, and wherein each stripe includes pages from multiple wordline locations.

Example 14 includes the semiconductor apparatus of any one of Examples 8 to 13, wherein the multiple types of pages include two or more of an extra page, an upper page or a lower page.

Example 15 includes a method of operating a performance-enhanced solid-state drive (SSD), the method comprising detecting a request to program a NAND memory containing a plurality of dies, and programming the NAND memory on a stripe-by-stripe basis, wherein each stripe spans the plurality of dies and includes multiple types of pages.

Example 16 includes the method of Example 15, wherein the multiple types of pages reduce a program time variability across the stripes.

Example 17 includes the method of any one of Examples 15 to 16, wherein the multiple types of pages reduce an error susceptibility of the NAND memory.

Example 18 includes the method of Example 15, wherein programming the NAND memory on the stripe-by-stripe basis includes reordering logical page addresses in a first die of the plurality of dies in accordance with a first configuration, and reordering logical page addresses in a second die of the plurality of dies in accordance with a second configuration, wherein the first configuration is different from the second configuration.

Example 19 includes the method of Example 15, wherein programming the NAND memory on a stripe-by-stripe basis includes starting a first program operation in a first die of the plurality of dies at a first wordline position, and starting a second program operation in a second die of the plurality of dies at a second wordline position, wherein the first wordline position is different from the second wordline position, and wherein each stripe includes pages from multiple wordline locations.

Example 20 includes the method of Example 15, further including prefilling a first die in the plurality of dies with dummy data to a first logical page address, and prefilling a second die in the plurality of dies with dummy data to a second logical page address, wherein the first logical page address is different from the second logical page address, and wherein each stripe includes pages from multiple wordline locations.

Example 21 includes means for performing the method of any one of Examples 15 to 20.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A solid state drive (SSD) comprising:
a device controller;
a chip controller; and
a NAND memory containing a plurality of dies, wherein one or more of the device controller or the chip controller include logic coupled to one or more substrates, the logic to:
detect a request to program the NAND memory, and
program the NAND memory on a stripe-by-stripe basis, wherein each stripe spans the plurality of dies and includes multiple types of pages.

2. The SSD of claim 1, wherein the multiple types of pages are to reduce a program time variability across the stripes.

3. The SSD of claim 1, wherein the multiple types of pages are to reduce an error susceptibility of the NAND memory.

4. The SSD of claim 1, wherein to program the NAND memory on the stripe-by-stripe basis, the logic is to:
reorder logical page addresses in a first die of the plurality of dies in accordance with a first configuration, and
reorder logical page addresses in a second die of the plurality of dies in accordance with a second configuration, wherein the first configuration is different from the second configuration.

5. The SSD of claim 1, wherein to program the NAND memory on the stripe-by-stripe basis, the logic is to:
start a first program operation in a first die of the plurality of dies at a first wordline position, and
start a second program operation in a second die of the plurality of dies at a second wordline position, wherein the first wordline position is different from the second wordline position, and wherein each stripe includes pages from multiple wordline locations.

6. The SSD of claim 1, wherein the logic is to:
prefill a first die in the plurality of dies is prefilled with dummy data to a first logical page address, and
prefill a second die in the plurality of dies is prefilled with dummy data to a second logical page address, wherein the first logical page address is different from the second logical page address, and wherein each stripe includes pages from multiple wordline locations.

7. The SSD of claim 1, wherein the multiple types of pages include two or more of an extra page, an upper page or a lower page.

8. A semiconductor apparatus comprising:
one or more substrates; and
logic coupled to the one or more substrates, wherein the logic is implemented at least partly in one or more of configurable or fixed-functionality hardware, the logic to:
detect a request to program a NAND memory containing a plurality of dies; and
program the NAND memory on a stripe-by-stripe basis, wherein each stripe spans the plurality of dies and includes multiple types of pages.

9. The semiconductor apparatus of claim 8, wherein the multiple types of pages are to reduce a program time variability across the stripes.

10. The semiconductor apparatus of claim 8, wherein the multiple types of pages are to reduce an error susceptibility of the NAND memory.

11. The semiconductor apparatus of claim 8, wherein to program the NAND memory on the stripe-by-stripe basis, the logic is to:
reorder logical page addresses in a first die of the plurality of dies in accordance with a first configuration; and
reorder logical page addresses in a second die of the plurality of dies in accordance with a second configuration, wherein the first configuration is different from the second configuration.

12. The semiconductor apparatus of claim 8, wherein to program the NAND memory on the stripe-by-stripe basis, the logic is to:
start a first program operation in a first die of the plurality of dies at a first wordline position; and
start a second program operation in a second die of the plurality of dies at a second wordline position, wherein the first wordline position is different from the second wordline position, and wherein each stripe includes pages from multiple wordline locations.

13. The semiconductor apparatus of claim 8, wherein the logic is to:
prefill a first die in the plurality of dies with dummy data to a first logical page address; and
prefill a second die in the plurality of dies with dummy data to a second logical page address, wherein the first logical page address is different from the second logical page address, and wherein each stripe includes pages from multiple wordline locations.

14. The semiconductor apparatus of claim 8, wherein the multiple types of pages include two or more of an extra page, an upper page or a lower page.

15. A method comprising:
detecting a request to program a NAND memory containing a plurality of dies; and
programming the NAND memory on a stripe-by-stripe basis, wherein each stripe spans the plurality of dies and includes multiple types of pages.

16. The method of claim 15, wherein the multiple types of pages reduce a program time variability across the stripes.

17. The method of claim 15, wherein the multiple types of pages reduce an error susceptibility of the NAND memory.

18. The method of claim 15, wherein programming the NAND memory on the stripe-by-stripe basis includes:
reordering logical page addresses in a first die of the plurality of dies in accordance with a first configuration; and
reordering logical page addresses in a second die of the plurality of dies in accordance with a second configuration, wherein the first configuration is different from the second configuration.

19. The method of claim 15, wherein programming the NAND memory on a stripe-by-stripe basis includes:
starting a first program operation in a first die of the plurality of dies at a first wordline position; and
starting a second program operation in a second die of the plurality of dies at a second wordline position, wherein the first wordline position is different from the second wordline position, and wherein each stripe includes pages from multiple wordline locations.

20. The method of claim 15, further including:
prefilling a first die in the plurality of dies with dummy data to a first logical page address; and
prefilling a second die in the plurality of dies with dummy data to a second logical page address, wherein the first logical page address is different from the second logical page address, and wherein each stripe includes pages from multiple wordline locations.
